(19) United States
(12) Patent Application Publication
(10) Pub. No.: US 2025/0267545 A1
(43) Pub. Date: Aug. 21, 2025

(54) INFORMATION PROCESSING DEVICE

(71) Applicant: TOYOTA JIDOSHA KABUSHIKI KAISHA, Toyota-shi (JP)

(72) Inventors: Hiroshi ABE, Kasukabe-shi (JP); Koji TAKEOKA, Yokohama-shi (JP); Kiichi IWASAKI, Nagoya-shi (JP); Takayuki SAKAI, Tokyo (JP); Isao NISHIOKA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/945,796

(22) Filed: Nov. 13, 2024

(30) Foreign Application Priority Data
Feb. 19, 2024 (JP) 2024-022707

(51) Int. Cl. H04W 40/12; H04W 40/04

(52) U.S. Cl. CPC H04W 40/12; H04W 40/04

(57) ABSTRACT

The information processing device includes a control unit. The control unit selects a communication path to be used for communication by using a first index based on a communication quality corresponding to each of a plurality of candidates of a communication path using two or more communication infrastructures and a second index that is an index other than the communication quality corresponding to each of the plurality of candidates with respect to an in-vehicle terminal that performs communication using two or more communication infrastructures of a plurality of communication carriers.

### CROSS-REFERENCE TO RELATED APPLICATION

This application claims priority to Japanese Patent Application No. 2024-022707 filed on Feb. 19, 2024, incorporated herein by reference in its entirety.

### BACKGROUND

### 1. Technical Field

The present disclosure relates to an information processing device.

### 2. Description of Related Art

Conventionally, there is a wireless communication method that creates a database in which position information and communication quality are associated (for example, Japanese Unexamined Patent Application Publication No. 2015-109509 (JP 2015-109509 A)).

### SUMMARY

The present disclosure can provide technology in which a suitable communication path can be selected.

One aspect of the present disclosure is an information processing device including
a control unit that selects a communication path used for communication using a first index and a second index in relation to an in-vehicle terminal that performs the communication using two or more communication infrastructures of a plurality of communication carriers, the first index being based on a communication quality corresponding to a plurality of candidates of the communication path of the communication using the two or more communication infrastructures, and the second index being an index other than for the communication quality corresponding to each of the candidates.

Another aspect of the present disclosure may include an information processing method, an information processing system that includes an information processing device, or a non-transitory storage medium that records a program.

According to the present disclosure, a suitable communication path can be selected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a first configuration example of a communication system;

FIG. 2A is a diagram illustrating a configuration example of a management server;

FIG. 2B is a diagram illustrating a configuration example of a terminal mounted on a moving body (vehicle);

FIG. 3 is a functional block diagram of a management server;

FIG. 4A is a diagram illustrating an example of a data structure of a network database (network DB);

FIG. 4B is a diagram showing an example of a data structure of a vehicle data base (vehicle DB);

FIG. 4C is a diagram illustrating an example of a data structure of a route database (route DB);

FIG. 5A is a diagram illustrating an example of a data structure of a service database (service DB);

FIG. 5B is a diagram illustrating an example of a data structure of a management database (management DB);

FIG. 6 is a flowchart illustrating an exemplary process for selecting a communication path; and

FIG. 7 is a flowchart illustrating a processing example of a usage fee calculation for each communication carrier.

### DETAILED DESCRIPTION OF EMBODIMENTS

Hereinafter, an embodiment of the present disclosure will be described below with reference to the drawings. The present disclosure is not limited by the embodiments described below.

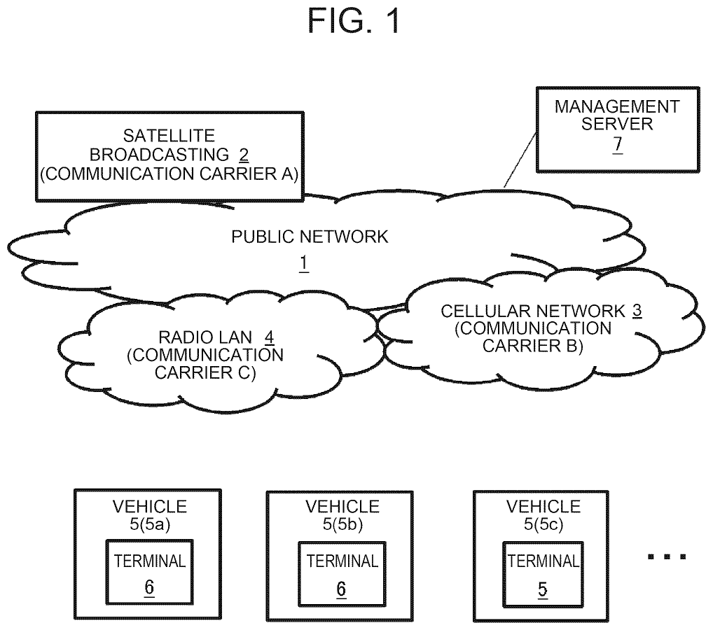

FIG. 1 is a diagram illustrating a configuration example of a communication system. In FIG. 1, the communication system includes a terminal 6 mounted on a vehicle 5 and a network used by the terminal 6 for communication. The terminal 6 is called a User Equipment (UE). The vehicle 5 is an example of a moving body, and the moving body is not limited to a vehicle. In the case illustrated in FIG. 1, the network includes a public network 1, a satellite communication network 2, a cellular network 3, and a radio LAN (Local Area Network) 4. The cellular network 3 and the radio LAN4 are used as an access network to the public network 1. The satellite communication network 2 is used, for example, when data transmitted from the public network 1, the cellular network 3, the radio LAN4, or the terminal 6 is received and data is broadcast to a predetermined terminal group. The cellular network is, for example, a 4G (LTE (Long Term Evolution)) or a 5G, 6G network. The radio LAN is a IEEE802.11 series-including Wi-Fi. However, the wireless communication network may be a wireless communication network that conforms to or conforms to other wireless communication standards.

The satellite communication network 2, the cellular network 3 and the radio LAN4 are owned or operated by mutually distinct communication carriers A, B and C. The communication carrier may be MNO (Mobile Network Operator) or MVNO (Mobile Virtual Network Operator). Each of the satellite communication network 2, the cellular network 3, and the radio LAN4 is an exemplary “communication infrastructure”. In the communication system shown in FIG. 1, a plurality of communication carriers A, B, and C have two or more (three) communication infrastructures (a satellite communication network 2, a cellular network 3, and a radio LAN 4).

In the communication system according to the embodiment, a plurality of communication infrastructures belonging to different communication carriers are managed in a unified manner. When the terminal 6 performs communication, a communication path that straddles two or more communication infrastructures can be established. That is, the communication system can establish a communication path that spans two or more communication carriers. The number of communication carriers may be two or more. In addition, the number of communication infrastructures of each communication carrier may be 1 or 2 or more.

The vehicles 5 are gasoline-powered vehicles, diesel-powered vehicles, or EV (Electric Vehicle). EV include plug-in hybrid electric vehicle (PHEV), fuel cell electric vehicle (FCV), or battery-powered battery electric vehicle (BEV). The vehicle 5 may be a vehicle driven by a driver or an autonomous vehicle. When communicating with a communication partner connected to the network, the terminal 6 transmits a communication request message to the network. The network establishes a communication path used for communication. At this time, as a communication path used for communication, a communication path using two or more communication infrastructures can be selected on the basis of a first index related to communication quality and a second index that is an index other than communication quality.

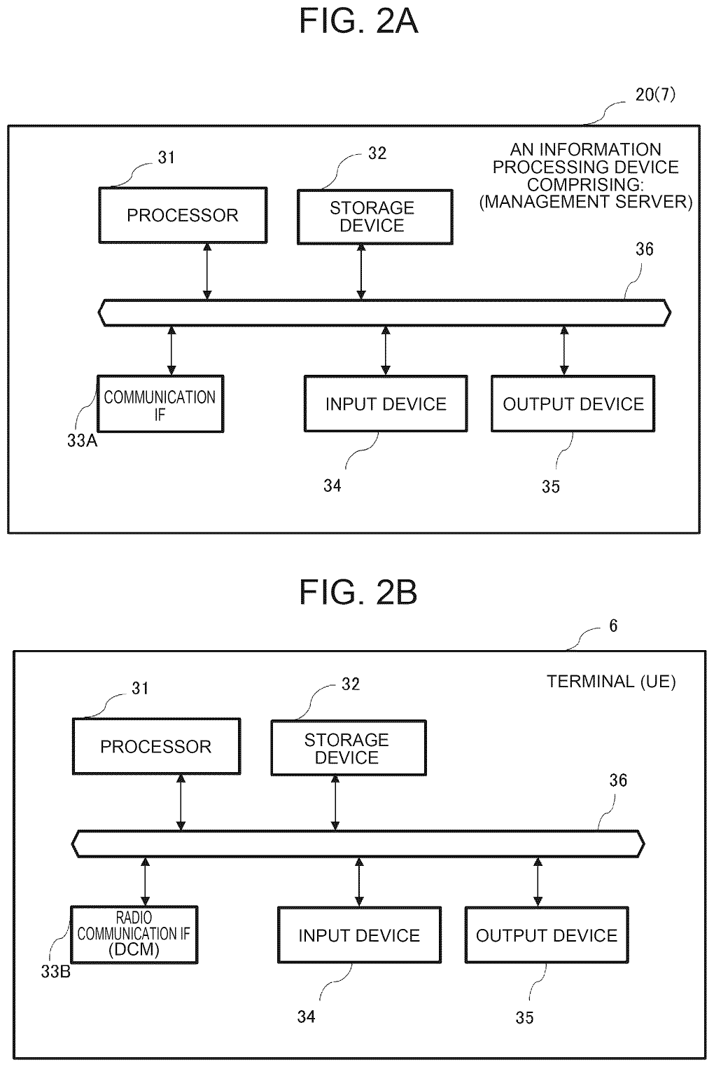

FIG. 2A is a diagram illustrating an example of a configuration of an information processing device 20 that can operate as the management server 7. The information processing device 20 can be configured using a general-purpose computer such as a personal computer (PC) or a workstation (WS), or a dedicated computer such as a server machine. The information processing device 20 has a communication function and is connectable to a network (such as the public network 1) by wire or wirelessly. The information processing device 20 may be one computer or a collection of two or more computers (cloud).

In FIG. 2A, the information processing device 20 includes a processor 31 as a processing unit or a control unit (controller), a storage device 32, a communication interface (communication IF) 33A, an input device 34, and an output device 35, which are connected to each other via a bus 36.

The storage device 32 includes a main storage device and an auxiliary storage device. The main storage device is used as a storage area for programs and data, a deployment area for programs, a work area for programs, and a buffer area for communication data. The main storage device is composed of a random access memory (RAM) or a combination of a RAM and a read only memory (ROM). The auxiliary storage device is used as a storage area for data and programs. As the auxiliary storage device, a non-volatile storage medium can be applied. Non-volatile storage media include, for example, hard disks, Solid State Drive (SSD), flash memories, and EEPROM (Electrically Erasable Programmable Read-Only Memory).

The communication IF 33A is a circuit that performs a communication process, and operates as a transmitter and a receiver (communication unit). For example, the communication IF 33A is a circuit that performs a wired connection or a wireless connection. The input device 34 includes keys, buttons, a pointing device, a touch panel, and the like, and is used for inputting information. The output device 35 is, for example, a liquid crystal display or an organic EL display, and displays information/data.

The processor 31 is, for example, a CPU (Central Processing Unit). The processor 31 performs various processes by executing various programs stored in the storage device 32.

FIG. 2B is a diagram illustrating an exemplary configuration of a terminal 6. The terminal 6 may be a terminal installed in the vehicle 10 or a portable terminal carried by a driver of the vehicle 5. The portable terminal is, for example, a laptop personal computer (PC), a smart device (such as a smart phone or a tablet terminal), or the like.

In FIG. 2B, the terminal 6 includes a processor 31, a storage device 32, an input device 34, and an output device 35, which are connected to each other via a bus 36, similar to the information processing device 20. A wireless communication interface (wireless communication IF) 33B performs processes related to wireless communication.

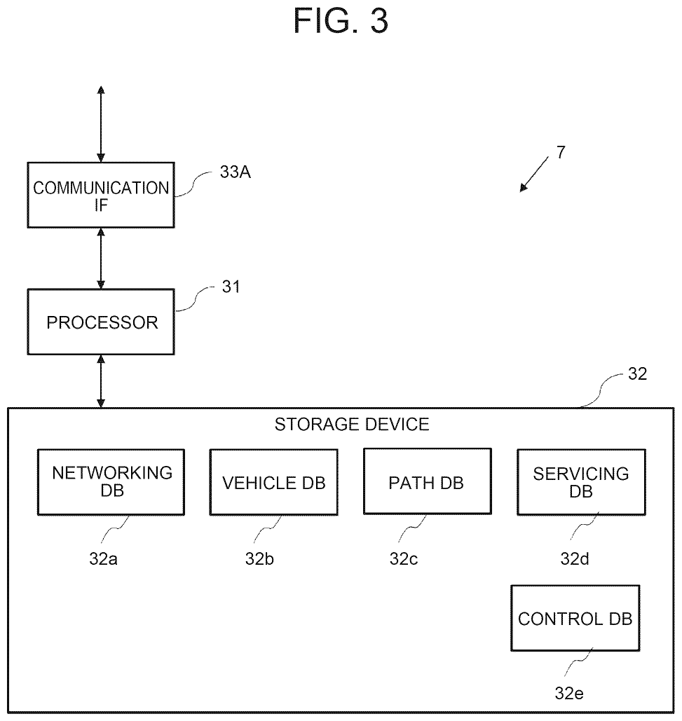

FIG. 3 is a diagram illustrating a configuration example of the management server 7. The information processing device 20 can operate as the management server 7 including the communication IF 33A, the processor 31, and the storage device 32 by the processor 31 executing a program stored in the storage device 32 or the like. In the storage device 32, for example, a network DB 32a, a vehicle DB 32b, a route DB 32c, a service DB 32d, and a management DB 32e are stored. The network DB 32a configures the network shown in FIG. 1, and stores information related to a plurality of communication infrastructures that are centrally managed. The vehicle DB 32b stores information related to the vehicle 5 including the terminal 6 capable of communicating using the network. The route DB stores information about communication path candidates available for communication by the terminal 6. The service DB 32d stores information related to a service used by the terminal 6 or provided to the terminal 6. The management DB stores information related to the communication path used by the terminal 6 in communication and information related to the usage fees of the respective communication infrastructures that provide the communication path.

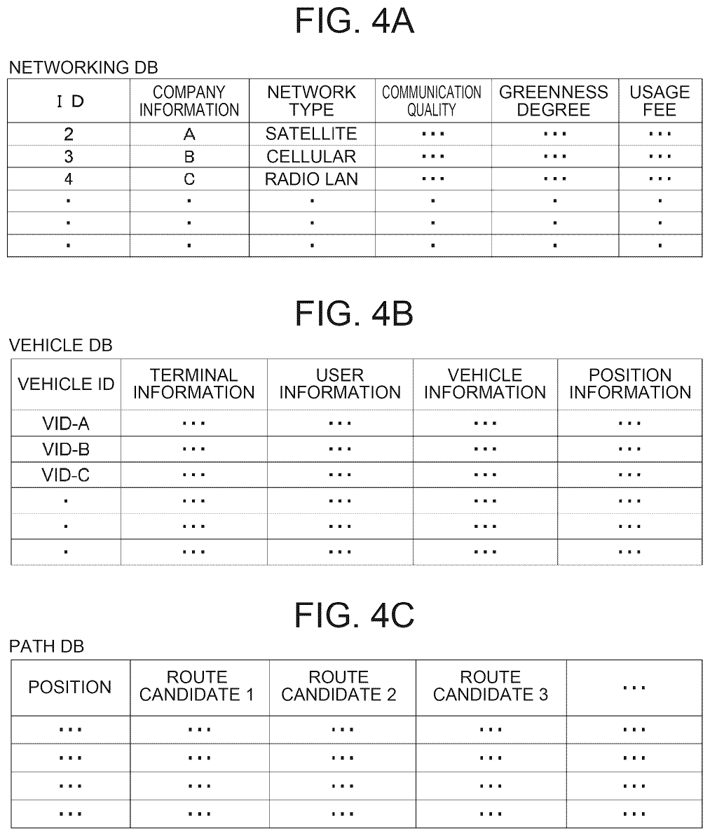

FIG. 4A is a block diagram illustrating an example of a data structure of a network DB 32a. The network DB 32a has a table structure consisting of records (entries) of communication infrastructures. The method includes the following steps: “ID” of the communication infrastructure, “operator information”, “network type”, “communication quality”, “greenness degree”, and “usage fee”. As “ID”, an ID is stored, which is unique identification-information assigned to the respective communication infrastructures. As “carrier information”, information related to a communication carrier that owns, operates, or manages a communication infrastructure is stored. As the “network type”, information indicating the type of communication infrastructure (for example, a satellite-based communication network, a cellular network, a radio LAN, or the like) is stored. The “communication quality” stores information indicating the communication quality that can be provided by the communication infrastructure, for example, information indicating a guaranteeable QoS (Quality of Service) parameter (throughput, transmission rate, latency (delay), or the like). The “greenness degree” is information indicating the degree of environmental emphasis. For example, the greenness degree is expressed by a usage rate (utilization rate) of green energy (renewable energy) used for operation of a communication infrastructure, an emission amount of a greenhouse gas, or the like. The “usage fee” stores information indicating a usage fee per communication unit (for example, packet unit) when the communication infrastructure is used.

FIG. 4B is a diagram illustrating an example of a data structure of a vehicle DB 32b. The vehicle DB 32b stores information related to the vehicle 5 (terminal) that is permitted to use a communication path that straddles two or more communication infrastructures. The vehicle DB 32b includes records (entries) for each vehicle. The entry includes “vehicle ID”, “terminal information”, “user information”, “vehicle information”, and “location information”. The “vehicle ID” stores vehicle ID that is unique identification information of the vehicle 5. As the “terminal information”, information related to the terminal 6 (included in the vehicle 5) associated with the vehicle 5 is stored. The terminal information is, for example, an ID of the terminal 6, a radio communication standard available (conforming or compliant) to the terminal 6, a network address, and the like. As “user information”, information related to an administrator of the vehicle 5, such as a user or an owner of the vehicle 5, is stored. As “vehicle information”, information related to the vehicle 5 is stored. The position information of the vehicle 5 (terminal 6) is registered as the “position information”. The position information may be information indicating the position of the terminal 6 directly (position coordinate data or the like) or information indicating the position of the terminal 6 indirectly (cell ID or the like). The position data may be acquired by the terminal 6 using a GPS receiver or the like, or may be acquired by a device other than the terminal 6. The management server 7 receives the position information of each vehicle 5 (terminal 6) from the network periodically or at an appropriate timing, and registers it in the “position information” of the corresponding entry. Note that a configuration may be adopted in which a terminal DB is provided instead of the vehicle DB 32b, and the information of the vehicle 5 associated with the entry for each terminal 6 is stored.

FIG. 4C is a diagram illustrating an example of a data structure of a route DB 32c. The route DB 32c stores information indicating one or more communication path candidates corresponding to the position information of the terminal 6. The information of the route candidate includes information indicating (specifying) one or more communication infrastructures through which the communication path passes, information indicating the order of passing of the two or more communication infrastructures, and information indicating an interface (gateway) between the communication infrastructures. At least one candidate route is prepared according to the position of the terminal 6. In accordance with a combination of two or more communication infrastructures, two or more arbitrary number of path candidates are prepared. However, one or more route candidates corresponding to the position of the terminal 6 and the communication partner (destination of data transmitted from the terminal 6) of the terminal 6 may be prepared.

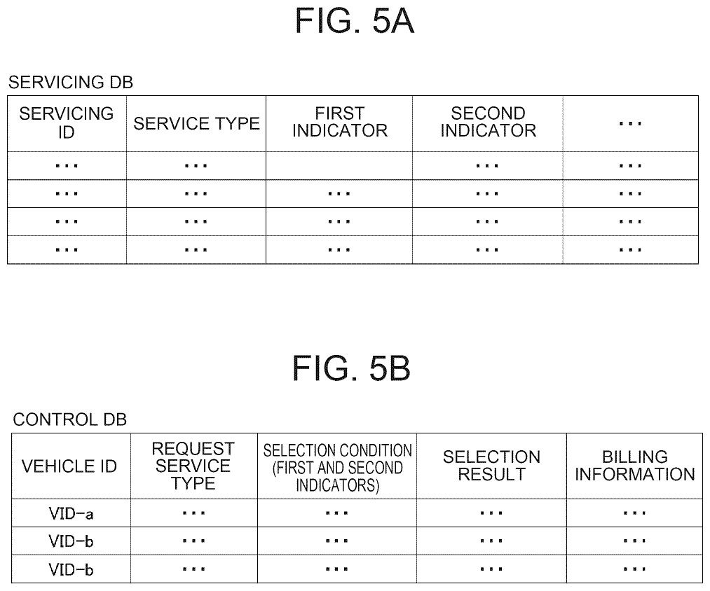

FIG. 5A is a diagram illustrating an example of a data structure of a service DB 32d. The service DB 32d includes an entry (record) for each service. The entry stores a service ID that is an identifier of the service, information indicating the service type, information indicating the first index corresponding to the service type, information indicating the second index corresponding to the service type, and the like. As the information indicating the first index, information indicating a communication quality (for example, a QoS parameter) requested, recommended, or suitable for the service specified by the “service type” is stored. Further, as the information indicating the second index, information indicating the greenness degree (information indicating the usage rate of green energy (for example, green power), or information indicating the emission amount of greenhouse gas, and the like) is stored.

FIG. 5B is a diagram illustrating an example of a data structure of a management DB 32c. The management DB 32e includes an entry (record) for each of the vehicles 5 (terminal 6) requesting provision of a service. The entry stores “request service type”, “selection condition”, “selection result”, and “billing information”. As the “request service type”, information indicating the type of service requested by the terminal 6 is stored. In addition, as the “selection condition”, information indicating a selection condition (a first index and a second index) of a communication path according to the “request service type” is stored. As the “selection result”, information indicating a communication path selected from one or more route candidates is stored. As the “billing information”, information indicating a billing for communication using the selected communication path and a breakdown (a billing amount (a distribution amount) distributed for each communication infrastructure) for each communication infrastructure is stored.

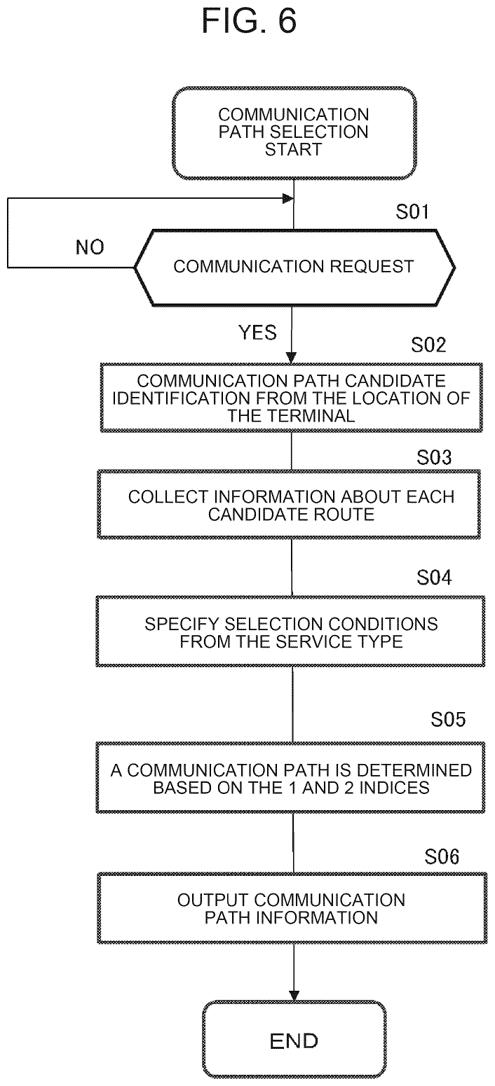

FIG. 6 is a flowchart illustrating a processing example of communication path selection. The processing illustrated in FIG. 6 is performed by the management server 7 (the processor 31). In S01, the management-server 7 receives a communication-request message from the terminal 6. The terminal 6 accesses the management server 7 before selecting a communication path. However, the communication request may be transmitted to the management server 7 by a network node of a communication infrastructure (such as the cellular network 3 or the radio LAN 4) that has received the communication request from the terminal 6. If it is determined in S01 that the communication request has been received, the process proceeds to S02.

In S02, the management server 7 identifies communication path candidates from the position of the terminal 6. In other words, the management server 7 acquires the position information corresponding to the terminal ID or the vehicle ID of the terminal 6 included in the communication request message from the vehicle DB 32b. The management server 7 reads, from the route DB 32c, information on route candidates corresponding to the positions of the terminals 6 specified from the acquired position information. As a result, one or more route candidates corresponding to the position are identified. However, the management server 7 may specify the route candidate from the location information and the destination information of the terminal 6. As the position information of the terminal 6, the position information included in the message of the communication request may be used for searching for the route candidate.

In S03, the management server 7 refers to the network DB 32a and reads out the information of the communication infrastructures included in the information of the route candidates to collect the information of the route candidates.

In S04, the management server 7 registers information (service ID) indicating ID of vehicles and the request service type included in the communication request message in the free entry of the management DB 32c. Further, the management server 7 refers to the service DB 32d, reads out the information indicating the first and second indexes (communication quality and greenness degree) corresponding to the service ID indicating the requested service type, and registers the information in the entry of the management DB 32e as the “selection condition”.

In S05, the management server 7 extracts the first and second indexes, that is, route candidates whose communication quality and greenness degree satisfy the selection condition, and selects (determines) one of the extracted one or more route candidates as a communication path to be used for communication. When two or more route candidates are extracted, the management server 7 may preferentially select the route candidate with the lowest usage fee, for example. That is, the processor 31 of the management server 7 may select one candidate having the lowest usage fee from two or more candidates satisfying the selection condition based on the first and second indexes extracted from the plurality of candidates. However, other selection methods may be employed.

In S06, the management server 7 registers the information of the selected communication path as a “selection result” and outputs the information. The output may be an output to the output device 35 or a transmission to a predetermined transmission destination. For example, the information of the communication path is transmitted to the network, and is transmitted to each communication infrastructure providing the communication path as the establishment information of the communication path, and the establishment procedure of the communication path is performed. This enables the terminal 6 to send the data to the destination through the established communication path. That is, data can be sent to a destination through a communication path that spans a plurality of types of communication infrastructure managed in a unified manner.

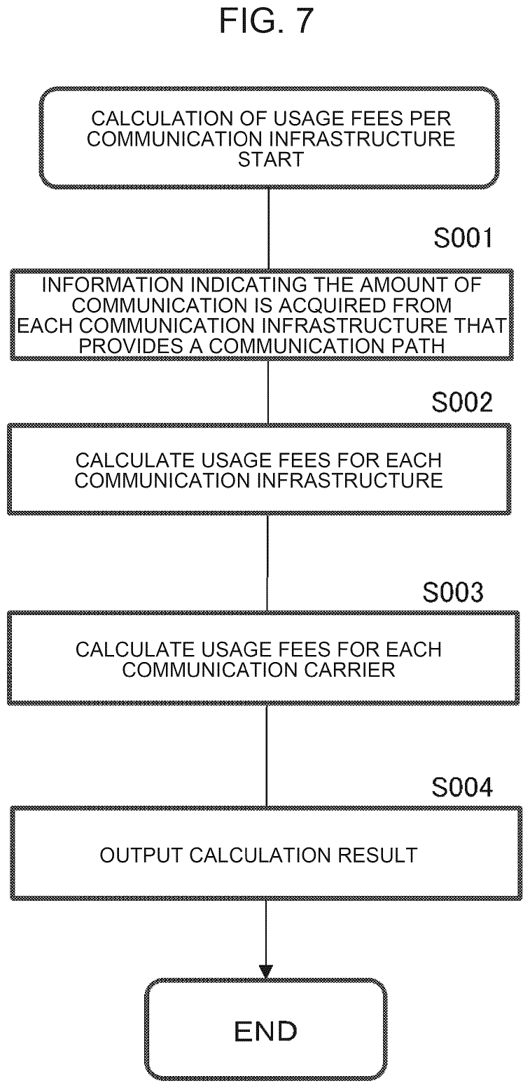

FIG. 7 is a flowchart illustrating a processing example of usage fee calculation for each communication infrastructure. The processing illustrated in FIG. 7 is performed by (the processor 31 of) the management server 7 during communication using the communication path established by the processing illustrated in FIG. 6.

In S001, the management server 7 acquires information indicating the amount of communication from the communication infrastructures that provide the communication path. In S002, the management server 7 calculates a usage fee for each communication infrastructure. For example, the management server 7 makes an inquiry to the network, acquires information indicating the number of packets transferred in each communication infrastructure on a packet-by-packet basis, and calculates a fee corresponding to the number of packets.

In S003, the management server 7 adds the usage fees for each communication infrastructure to each communication carrier. Although not shown in the example shown in FIG. 1, this is because when a communication path passes through two or more communication infrastructures of one communication carrier, a total value can be presented to the communication carrier. S004 is used to calculate the usage fee for each communication carrier (distribution amount to each communication carrier). The output may be an output to the output device 35 or may be a transmission of data indicating a calculation result to a predetermined destination.

According to the embodiment, the processor 31 (control unit) of the management server 7 (information processing device) performs the following operations. That is, the processor 31 selects a communication path used for communication using the first index and the second index of the plurality of candidates (route candidates) of the communication path using the two or more communication infrastructures with respect to the terminal 6 (in-vehicle terminal) that performs communication using the two or more communication infrastructures of the plurality of communication carriers A, B, and C. The first index is based on a communication quality corresponding to each of a plurality of candidates (path candidates) of a communication path of communication using two or more communication infrastructures. The second index is an index other than the communication quality corresponding to each of the plurality of candidates. As a result, it is possible to select a communication path that is more suitable than the case where each of the communication carriers provides the communication service by using the communication infrastructure of the communication carrier alone. For example, it is possible to perform communication using a communication path having a higher communication quality and a higher usage rate of green energy than in a case where a service is provided by a communication infrastructure owned by each communication carrier. In other words, it is possible to provide flexibility in the selection of the communication path and to perform communication with enhanced communication quality and greenness degree.

The processing in the management server 7 may be executed by the processor 31 of the terminal 6 after the terminal 6 acquires the information for performing the processing in FIG. 6 and FIG. 7 from the management server 7 or a peripheral device such as a road beacon. The terminal 6 is an example of an information processing device according to the present disclosure.

Note that the order of the processes (steps) in the flowcharts of FIG. 6 and FIG. 7 can be changed within a range that does not contradict each other. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration for implementing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include, for example, magnetic disks, disks of any type, read only memory (ROM), random access memory (RAM), EPROM, EEPROM, magnetic cards, flash memory, optical cards, any type of media suitable for storing electronic instructions. Optional types of discs are optical discs (CD-ROM, DVD discs, Blu-ray discs, etc.) and the like. The magnetic disk is a floppy disk, a hard disk drive (HDD), or the like.

What is claimed is:

1. An information processing device comprising a control unit that selects a communication path used for communication using a first index and a second index in relation to an in-vehicle terminal that performs the communication using two or more communication infrastructures of a plurality of communication carriers, the first index being based on a communication quality corresponding to a plurality of candidates of the communication path of the communication using the two or more communication infrastructures, and the second index being an index other than for the communication quality corresponding to each of the candidates.

2. The information processing device according to claim 1, wherein the second index is a greenness degree of each of the communication infrastructures corresponding to each of the candidates.

3. The information processing device according to claim 2, wherein the greenness degree is a usage rate of green energy in each of the communication infrastructures or an emission amount of greenhouse gas in each of the communication infrastructures.

4. The information processing device according to claim 1, wherein when two or more candidates satisfying a selection condition based on the first index and the second index are extracted from the candidates, the control unit selects one candidate having a lowest usage fee from the two or more candidates.

5. The information processing device according to claim 1, wherein the control unit outputs information that indicates a distribution amount in which a usage fee of the two or more communication infrastructures used for the communication is distributed to each of the communication carriers in accordance with a determined communication path.
